(19) United States
(12) Patent Application Publication
(10) Pub. No.: US 2004/0080601 A1
(43) Pub. Date: Apr. 29, 2004

(54) Color thermal printer

(75) Inventors: Akihiko Machida, Saitama (JP); Nobuo Katsuma, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/690,720

(22) Filed: Oct. 23, 2003

(30) Foreign Application Priority Data
Oct. 23, 2002 (JP) 2002-308648

(51) Int. Cl. B41J 11/00

(52) U.S. Cl. 347/172

(57) ABSTRACT

The thermosensitive color recording paper is rolled around a roll core. On a side of the roll core, a code of fixing sensitivity of the thermosensitive color recording paper to a fixing light is depicted. The code is read by a code reading device, and a code data of the code is input in a controller. The controller obtains from a data table memorized in a memory a light quantity of the fixing light that corresponds to the code data. On the basis of the light quantity, the target luminance of fixing lamps and a target feeding velocity of the thermosensitive color recording paper are determined so as to be adequate for a sort of the thermosensitive color recording paper. In the luminance and the feeding velocity, the optical fixation of said each mono-color image is performed.

### BACKGROUND OF THE INVENTION

1. Field of the Invention

The present invention relates to a color thermal printer for printing a full-color image on a thermosensitive color recording paper by performing a thermal recording and an optical fixing.

2. Description Related to the Prior Art

As described in Japanese Patent Laid-Open Publication No. 05-104753, a conventional color thermal printer is known, which performs thermal recording of a full-color image on a thermosensitive color recording paper in which three of yellow, magenta and cyan coloring layers are overlaid on a base. The color thermal printer includes a thermal head extending in a scanning direction. While the color thermal printer feeds the thermosensitive color recording paper in a sub-scanning direction, the thermal head heats the thermosensitive color recording paper to form three mono-color images sequentially on a surface of the thermosensitive color recording paper.

The yellow coloring layer is heated to turn in yellow, and loses coloring capacities in illumination of a yellow fixing light having a peak whose wavelength is about 420 nm. Further, the magenta coloring layer is heated to turn in magenta, and loses coloring capacities in illumination of a magenta fixing light having a peak whose wavelength is about 365 nm. After the recording, the yellow and magenta fixing lights are applied to the thermosensitive color recording paper to respectively fix the yellow and magenta coloring layers. Thus it is prevented that uncolored part of the previously recorded yellow or magenta coloring layer is colored unnecessarily, when the recording in the lower recording layer is performed.

A fixing device for performing the fixing is constructed of a yellow fixing lamp for irradiating the yellow fixing light and a magenta fixing lamp for irradiating the magenta fixing light. However, the wavelength range of the yellow fixing light which the yellow fixing lamp irradiates includes a wavelength element of the magenta fixing light. Therefore when the light quantity of the yellow fixing light is too large, then the coloring capacities of the magenta coloring layer are smaller. Therefore, the coloring density of the magenta image becomes lower. Further, when the light quantity of the yellow fixing light is not enough, the unfixed part is colored during the recording of the following coloring layer. Thus the color mixture occurs. Therefore, in the color thermal printer, the light quantity of the fixing light is preset so as to be adequate for the previously determined heat sensitivity of the thermosensitive color recording paper. Then the fixing is performed on the basis of the preset light quantity.

However, in the conventional thermal printer as described in the publication No. H05-104753, the light quantity of the fixing light is preset. Therefore the sorts of the usable thermosensitive color recording papers are limited to that having the fixing sensitivity adequate for the determined light quantity, and other sorts of the thermosensitive recording papers cannot be used. Accordingly, there is no known color thermal printer, in which different sorts of the thermosensitive color recording papers are usable.

### SUMMARY OF THE INVENTION

An object of the present invention is to provide a color thermal printer in which different sorts of thermosensitive color recording papers having different levels of fixing photo sensitivity can be used.

In order to achieve the object and the other objects, a color thermal printer of the present invention includes a fixing device for selectively fixing the coloring layers of the thermosensitive color recording paper, an input device for inputting information for setting a light quantity of each of the coloring layers, and a controller for controlling the fixing device such that each the coloring layer may be illuminated in the light quantity of the fixing light that depends on the information. The light quantity of the fixing light for each the coloring layer is determined in accordance with a sort of the thermosensitive color recording paper.

In the preferable embodiment, the information is recorded on a side surface of the roll core around which the continuous thermosensitive color recording paper is rolled. Information reading device is disposed so as to confront to the roll core.

According to the color thermal printer of the present invention, the information of a fixing sensitivity of the thermosensitive color recording paper is input into the color thermal printer, and the fixing light is irradiated on the basis of the information of the fixing sensitivity. Accordingly, a good full-color image can be recorded even on the thermosensitive color recording paper having different fixing sensitivity to the fixing light.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a color thermal printer of the present invention;

FIG. 2 is a block diagram illustrating an electric structure of the color thermal printer;

FIG. 3 is a flow chart when the color thermal printer prints a full-color image; and

FIG. 4 is an explanatory view illustrating a layer structure of thermosensitive color recording paper.

### PREFERRED EMBODIMENTS OF THE INVENTION

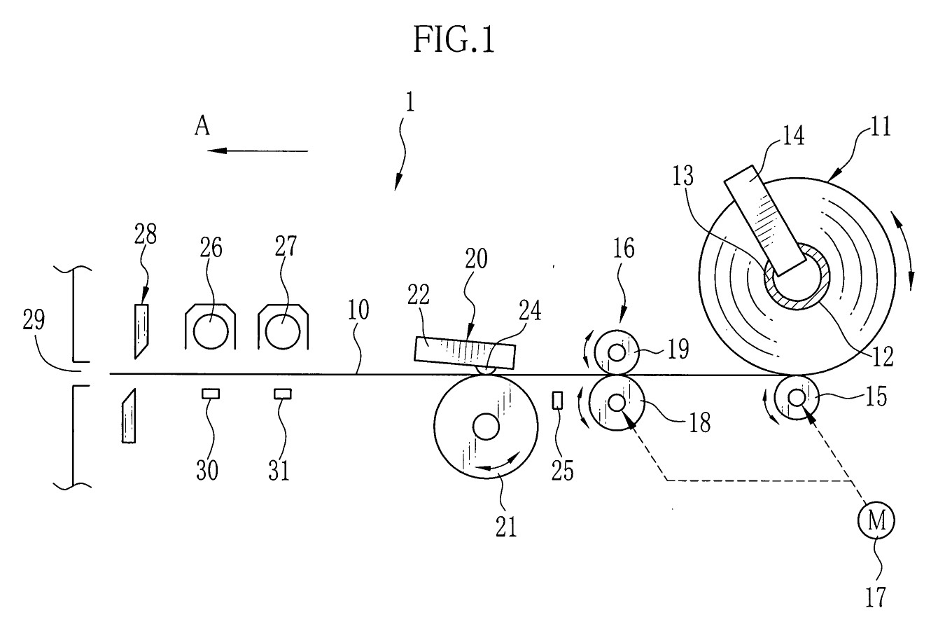

In FIG. 1, a recording paper roll 11 in which the thermosensitive color recording paper 10 is rolled around a roll core 12 is set to the color thermal printer 1. The roll core is formed of, for example paper or plastic. On a side of a roll core 12 is printed a code 13 representing informations about fixing sensitivity of the thermosensitive color recording paper 10. A code reading device 14 as input device is provided in the color thermal printer 1 so as to encounter the side of the recording paper roll 11, and reads the code 13. The recording paper roll 11 is rotated by a supply roller 15 contacting to a periphery of the recording paper roll 11, and the feeding and rolling of the thermosensitive color recording paper 10 is made.

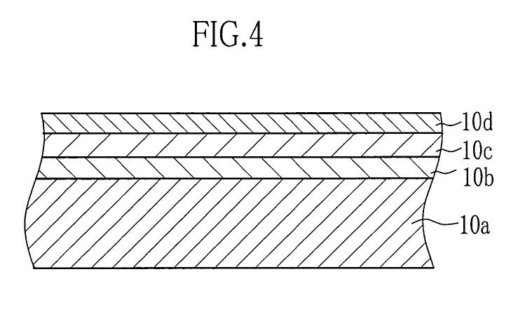

As shown in FIG. 4, the thermosensitive color recording paper 10 has a base 10a and cyan, magenta and yellow coloring layers 10b-10d which are overlaid on the base 10a in this order. The yellow coloring layer 10d is the uppermost layer and has the highest heat sensitivity to turn in yellow when heated with the smallest thermal energy. The cyan coloring layer 10b is the lowest layer and has the lowest heat sensitivity to turn in cyan when heated with the largest thermal energy. Further, the yellow coloring layer 10d loses coloring properties when the yellow fixing light having a peak in the wavelength range around 420 nm is applied. The magenta coloring layer 10c turns in magenta when heated with the thermal energy between the yellow coloring layers 10d and the cyan coloring layers 10b, and loses the fixing properties when the magenta fixing light having a peak in the wavelength range around 365 nm is applied. Further, there are types of the thermosensitive color recording paper 10 in which it is necessary to perform the bleach-fixing to a blank outside of the recording area or to a blank portion of the recording area.

Downstream from the recording paper roll 11 in a paper supply direction is disposed a feed roller pair 16 for nipping and feeding the thermosensitive color recording paper 10. The feed roller pair 16 is constructed of a capstan roller 18 rotated with a feed motor 17 and a pinch roller 19 which is biased so as to contact to the capstan roller 18. The thermosensitive color recording paper 10 is fed in the left direction (or the paper supply direction) for feeding the thermosensitive color recording paper 10) and in a right direction (or a printing direction) for rolling the thermosensitive color recording paper 10. Note that the coloring layers 10b-10d are disposed in upper side of the base 10a in this figure.

Downstream from the feed roller pair 16 are disposed a thermal head 20 and a platen roller 21 so as to nip the thermosensitive color recording paper 10 in a feed path. In the thermal head 20, a ceramic base plate is attached to a lower surface of a head base plate 22 which is formed of metal having a good thermal conductivity. On a lower surface of the head base plate 22 are aligned many heating elements to form a heating element array 24 in a scanning direction perpendicular to the paper supply direction.

The platen roller 21 is disposed downwards from the feed path so as to confront to the heating element array 24, and biased toward the thermal head 20 by a spring (not shown). Further, the platen roller 21 is shiftable in up- and downward directions against the pressure of the spring.

The thermal head 20 presses the thermosensitiv color recording paper 10 such that the heating element array 24 may contact to thermosensitive color recording paper 10. In this situation, each heating element is driven to generate heat so as to color each coloring layer. The platen roller 21 rotates in accordance with the feeding of the thermosensitive color recording paper 10.

Between the feed roller pair 16 and the platen roller 21 is disposed an edge sensor 25 for detecting a forward edge of the thermosensitive color recording paper 10. As the edge sensor 25, for example, there is a photo interrupter including a projecting section for projecting a detection light and a receiving section for receiving the detection light which has been reflected on the thermosensitive color recording paper 10.

Downstream from the thermal head 20 in the paper supply direction are disposed a yellow fixing lamp 26 and a magenta fixing lamp 27 which construct a fixing device. The yellow fixing lamp 26 irradiates as the yellow fixing light a near UV-ray having a peak in wavelength range around 420 nm, to fix the yellow coloring layer 10d of the thermosensitive color recording paper 10. The magenta fixing lamp 27 irradiates as the magenta fixing light a near UV ray having a peak in wavelength range around 365 nm, to fix the magenta coloring layer 10c of the thermosensitive color recording paper 10. The magenta fixing lamp 27 is used for the bleach-fixing of the blanks.

The thermal printer 1 has a yellow fixing luminance sensor 30 which is sensitive to the yellow fixing light and a magenta fixing luminance sensor 31 which is sensitive to the magenta fixing light. The luminance sensors 30, 31 are confronted to respective edge portions of the yellow and magenta fixing lamps 26 and 27. In this embodiment, the length of each yellow and magenta fixing lamp 26, 27 is larger than the width of the thermosensitive color recording paper 10, and the edge portions of the each yellow and magenta fixing lamps 26, 27 are positioned in outer sides of the thermosensitive color recording paper 10. Accordingly, the fixing lights toward the luminance sensors 30, 31 are not shielded by the thermosensitive color recording paper 10.

Downstream from the yellow fixing lamp 26 in the paper supply direction, there is a cutter for cutting the continuous thermosensitive color recording paper 10 at every recording area. Downstream from a cutter 28, an exit 29 is formed for ejecting the print sheet out from the thermal printer 1.

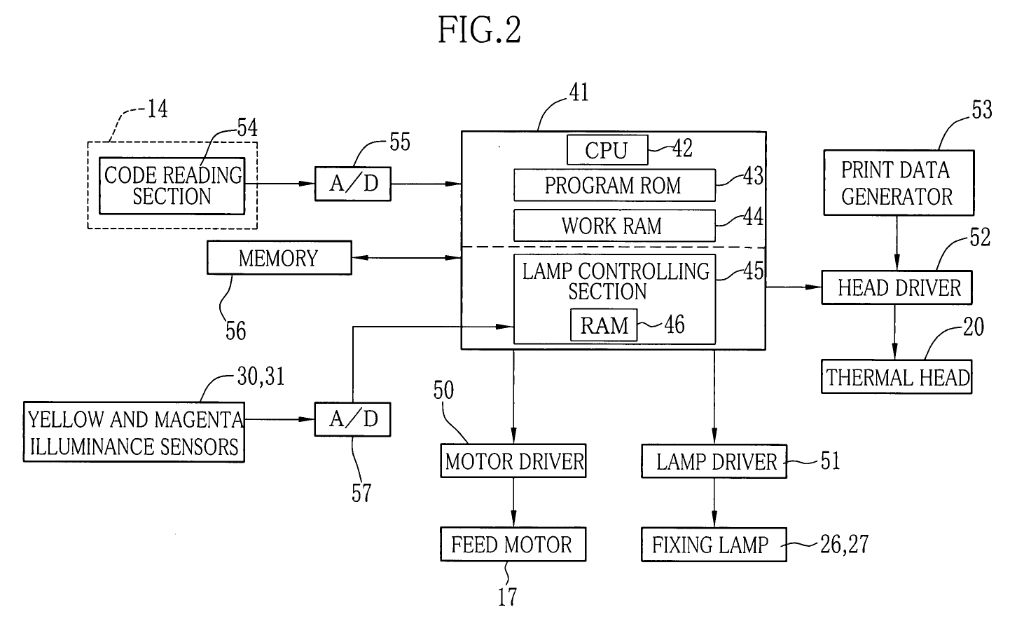

As shown in FIG. 2, a system controller 41 is constructed of a CPU 42, a program ROM 43, a work RAM 44, a lamp controlling section 45 and the like. The CPU 42 controls each part of the thermal printer 1 depending on a controlling program memorized in the program ROM 43. In the work RAM 44 is memorized a temporary data which generates during the control. Further, the lamp controlling section 45 controls the yellow and magenta fixing lamps 26, 27 through a lamp driver 51.

The controller 41 is connected to a motor driver 50, a lamp driver 51, and a head driver 52. On the basis of a control signal from the controller 41, the motor driver 50 generates a drive pulse for driving the feed motor 17 which is a stepping motor. The number of the drive pulse generated in the motor driver 50 is counted by the controller 41 and utilized for controlling the amount of feeding the thermosensitive color recording paper 10.

A print data generator 53 transforms the image data of the BGR form into a print data of the YMC form. The head driver 52 receives the print data from the print data generator 53 at every line of each color, and the print data at each line is converted into a drive signal to drive the each heating element of the heating element array 24.

Further, the code reading section 54 as input device provided in the code reading device 14 reads from the roll core 12 the code 13 representing the information of fixing sensitivity of the thermosensitive color recording paper 10. Then the analog signal is converted to a digital data by the A/D converter 55, and the digital data is input in the controller 41.

When the code 13 is the optical information such as bar code and the like, the code reading section 54 is an optical reading device having a light projector and a light receiver (photosensor). Further, when the code is a magnetic information, the code reading section 54 is a magnetic reading device having a magnetic head.

Further, the controller 41 is connected to a memory 56 in which a data table of the light quantity of the fixing light is memorized. In the data table, the light quantity of the fixing light corresponds to the code 13. An example of the data table is illustrated in Table 1.

TABLE 1

| | Y-Light | M-Light | BF- Light |
|---|---|---|---|
| Code | quantity | quantity | quantity |
| 0001 | 100 | 100 | 0 |
| 0002 | 100 | 110 | 50 |
| 0003 | 50 | 50 | 30 |
| 0004 | 100 | 80 | 50 |
| . | . | . | . |
| . | . | . | . |
| . | . | . | . |

As shown in Table 1, the data table shows the relative value (%) of the respective light quantities necessary for the fixing of the yellow and magenta coloring layer 10d, 10c and the bleach-fixing. This data table teaches that the light quantities necessary for fixing the yellow and magenta coloring layers 10d, 10c and bleach-fixing are different between sorts of paper. Further, there is a type of the thermosensitive recording paper 10 of fixing sensitivity code 0001, for which the bleach-fixing is not necessary. Otherwise, there are types of the thermosensitive recording paper 10 of fixing sensitivity codes 0002-0004, for which the bleach-fixing is necessary. As a standard light quantity of the fixing light is memorized in a program ROM 43, the lamp controlling section 45 calculates a target light quantity of the fixing light of each color and an target light quantity of the light for the blank fixing with reference to the standard light quantity of each color, and the target light quantities are written in a RAM 46.

The illuminance sensors 30, 31 are connected to the controller 41 through the A/D converter 57. The measured light quantities which are measured by the illuminance sensors 30, 31 are converted to the digital data, and the digital data is input in the lamp controlling section 45. The light quantity of the fixing light depends on both feeding velocity of the thermosensitive color recording paper 10 and luminance of the each lamp. Accordingly, the combination of them for each light quantity of the fixing light is memorized in the memory 56. The controller 41 determines the target feeding velocity of the thermosensitive color recording paper 10 and target luminance of each yellow and magenta fixing lamps 26, 27 on the basis of the target light quantity memorized in the RAM 46. The controller 41 controls the motor driver 50 and the lamp driver 51 so as to perform the feeding of the thermosensitive color recording paper 10 at the target feeding velocity and the irradiating of the fixing light the target luminance.

In this embodiment, in order to irradiate the fixing light of the target light quantity, both the target luminance and the target feeding velocity are controlled. However, one of them may be kept unchanged, and another may be calculated from the target light quantity of the fixing light. For example, the feeding velocity may be unchanged, and the target luminance may be calculated from the target light quantity of the fixing light. Further, 90% of the measured luminance which is measured by the luminance sensors 30, 31 is determined as the target luminance, and the target feeding velocity may be determined from this target luminance and the target light quantity of the fixing light.

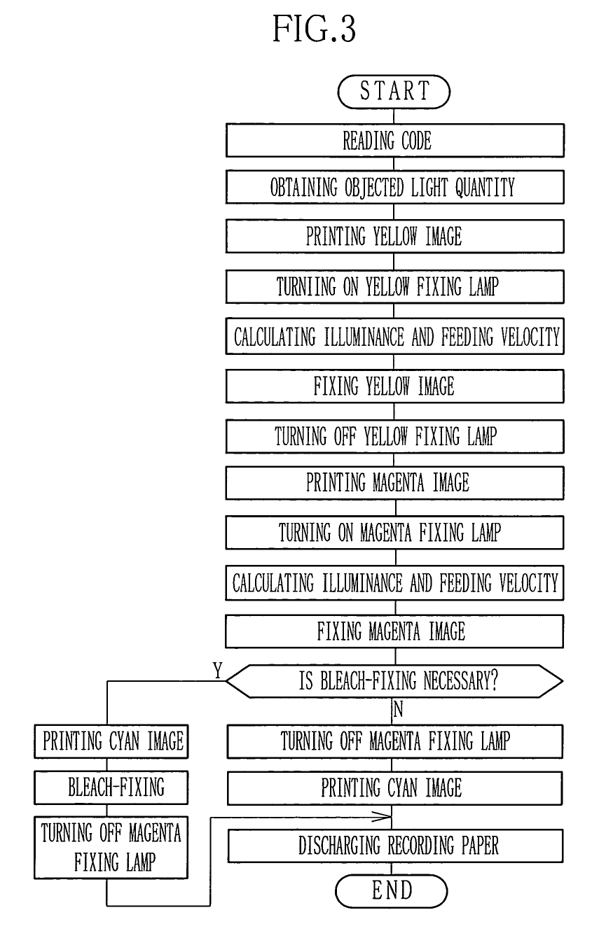

Effects of the color thermal printer 1 of the present invention will be described with reference to FIG. 3. When the printing is instructed, the controller 41 starts driving the motor driver 50 to control the normal rotation of the feed motor 17. As shown in FIG. 1, the feed motor 17 rotates the supply roller 15 in anti-clockwise direction. The recording paper roll 11 contacting to a periphery of the supply roller 15 rotates in the clockwise direction, such that the thermosensitive color recording paper 10 is supplied in the feed path.

During the rotation of the recording paper roll 11, the code reading section 54 of the code reading device 14 reads the code 13 printed on the side of the roll core 12 of the recording paper roll 11. The analog signal of the code 13 is converted to the digital data in the A/D converter 55, and the digital data is sent to the controller 41. On the basis of the digital data, the controller 41 extracts from the data table in the memory 56 the data of the relative value for each color that corresponds to the code 13. Then the relative value is converted to the target light quantity of the fixing light in reference to the standard light quantity of the fixing light for each color, and the target light quantity is memorized in the RAM 46.

The forward edge of the thermosensitive color recording paper 10 passes between the capstan roller 18 and the pinch roller 19, and then is detected by the edge sensor 25. When the forward edge is detected, the pinch roller 19 is shifted downwards by a shifting mechanism (not shown), and the thermosensitive color recording paper 10 is nipped between the capstan roller 18 and the pinch roller 19. Further, the controller 41 starts counting the number of the drive pulse input from the motor driver 50 to the feed motor 17 so as to determine the amount of feeding the thermosensitive color recording paper 10 on the basis of the number of the drive pulse.

When the thermosensitive color recording paper 10 is fed by one frame, then the feed motor 17 stops. During stop of the feed motor 17, the platen roller 21 is shifted upwards by a shifting mechanism (not shown) such that the thermosensitive color recording sheet 10 is nipped between the heating element array 24 and the platen roller 21.

Then the feed motor 17 starts rotating reversively, and the thermosensitive color recording sheet 10 is fed in the reverse direction to the arrowed direction A. During the feed of the thermosensitive color recording sheet 10, the controller 41 drives the head driver 52 and converts the print data into the drive data to drive each heating element and to form one line of the yellow image in the yellow coloring layer 10d. After the end of the recording of the one line of the yellow image, when the thermosensitive color recording paper 10 is fed by one line, the second line of the yellow image is printed.

The recording of the one line of the yellow image is repeated. Thus the yellow image is completely recorded. The controller 41 drives the shift mechanism (not shown) to shift the platen roller 21 to release the nip of the thermosensitive color recording paper 10.

The controller 41 drives the feed motor 17 to rotate normally and to feed the thermosensitive color recording paper 10 in the paper supply direction. At start of the feeding, the controller controls the lamp driver 51 to light the yellow fixing lamp 26 on. The controller 41 determines the target luminance of the yellow fixing lamp 26 and the target feeding velocity of feeding the thermosensitive color recording paper 10 in reference to the light quantity data of the required light quantity.

The controller 41 actuates the motor driver 50 to feed the thermosensitive color recording paper 10 in the target feeding velocity. Further, the controller 41 actuates the lamp driver 51 to make a feed-back control such that the measured luminance measured by the luminance sensor 30 may become the target luminance.

Thus the print area is illuminated in the UV-ray uniformly, and the fixing of the yellow coloring layer 10d is completed. Then the controller 41 stops the feeding of the thermosensitive color recording paper 10 and turns off the yellow fixing lamp 26.

When the fixing of the yellow coloring layer 10d is completed, the controller 41 starts feeding the thermosensitive color recording paper 10 in the rolling direction. When the back end of the print area reaches the print position of the heating element array 24 of the thermal head 20, then the feeding of the thermosensitive color recording paper 10 in the rolling direction stops.

While the feeding of the thermosensitive color recording paper 10 stops, the platen roller 21 contacts to press the thermosensitive color recording paper 10. And the thermosensitive color recording paper 10 is further fed in the same fashion of printing the yellow image, and thereby the recording of the magenta image in the magenta coloring layer 10c is performed line by line.

When the recording of the magenta image in the print area is completed, the feeding of the thermosensitive color recording paper 10 in the rolling direction stops. Further, the platen roller 21 releases the nip of the thermosensitive color recording paper 10, and it is fed in the paper supply direction. Then the magenta fixing lamp 27 is turned on.

Thereby the controller 41 determines the target luminance of the magenta fixing lamp 27 and the target feeding velocity of feeding the thermosensitive color recording paper 10 on the basis of the target light quantity of the magenta fixing lamp 27 that is memorized in the RAM 46.

Thereafter, on the basis of the target feeding velocity and the target luminance, the controller 41 controls the motor driver 50 and the lamp driver 51 to fix the recorded magenta coloring layer 10c.

When the bleach-fixing is not necessary for the thermosensitive color recording paper 10 (for example the code 0001 in the table 1), then the magenta fixing lamp is turned off after the fixing of the magenta image.

Thereafter the thermosensitive color recording paper 10 is fed in the rolling direction in the same fashion of printing the yellow and magenta images, and thereby the recording of the cyan image in the cyan coloring layer 10b is performed line by line.

When the recording of the cyan image is completed, the thermosensitive color recording paper 10 is fed in the paper supply direction A and cut by a cutter to obtain the print area as the print sheet. The print sheet is ejected through the exit 29, to terminate the printing operation.

Otherwise, when the bleach-fixing is necessary for the thermosensitive color recording paper 10 (for example the codes 0002 in the table 1), then the controller 41 determines the target luminance of the magenta fixing lamp 27 and the target feeding velocity of the thermosensitive color recording paper on the basis of the target light quantity for bleach-fixing.

Thereafter, the magenta fixing lamp 27 is kept to irradiate, the thermosensitive color recording paper 10 is fed in the rolling direction, and the recording of the cyan image is performed line by line.

After the end of the recording of the cyan image, the thermosensitive color recording paper 10 is fed in the paper supply direction, and thereby the bleach-fixing of the blank is made. In the bleach-fixing, the magenta fixing lamp 27 and the feed motor 17 are controlled on the basis of the target feeding velocity and the target luminance. After the bleach-fixing, the magenta fixing lamp 27 is turned off. The thermosensitive color recording paper 10 is fed in the paper supply direction A and cut by a cutter.

As the fixing light is irradiated so as to have the adequate luminance for the fixing sensitivity of the thermosensitive color recording paper, the several sorts of the thermosensitive color recording papers are used in the thermal printer 1. Further, the thermal printer 1 can discriminate whether the bleach-fixing is necessary for the thermosensitive color recording paper. When it is not necessary, then the magenta fixing lamp is turned off after the fixing of the magenta image. Accordingly, the waste of the electric energy is reduced.

In the table data illustrated in Table 1, the relative value is used. Instead of the relative value, the absolute value of the light quantity of the fixing light may be used. Further, the fixing sensitivity code is a code substantially representing the sort of the thermosensitive color recording paper. However, three codes representing the respective light quantities of three the fixing light may be recorded on the roll core, and each read code may be converted to the target light quantity in reference to the table. Further, an incidental error may occur in reading operation of the code reading device. In this case, the error may be indicated, or the minimum value of the light quantity may be preset. Further, a structure without the code reading device may be provided. In this case, the code of the target light quantity of the fixing light may be manually input.

Further the recording medium may be a sheet type of the thermosensitive color recording paper. In this case, the code is indicated on a rear surface of the thermosensitive color recording paper, and the code reading device may be disposed downwards from the feed path of the thermosensitive color recording paper.

Various changes and modifications are possible in the present invention and may be understood to be within the present invention.

What is claimed is:

1. A color thermal printer for recording an image on a thermosensitive color recording paper, said thermosensitive color recording paper having first-N^{th} (N is an integer number of at least 2) coloring layers, a printing of said coloring layers being performed from said first coloring layer as an uppermost coloring layer by a thermal head sequentially toward a paper base, said first-(n−1)^{th} coloring layers being fixed with first-(n−1)^{th} fixing light having a respective specific wavelength range shortly after heated, said color thermal printer comprising:
a fixing device for irradiating said first-(n-1)^{th} fixing light selectively to said thermosensitive color recording paper;
an input device for inputting information for setting a light quantity of said fixing light for each said coloring layer, said light quantity of each said fixing light being predetermined in accordance with a sort of said thermosensitive color recording paper; and
a controller for controlling said fixing device such that each said coloring layer may be illuminated by said fixing light in said light quantity that depends on said information.

2. A color thermal printer as claimed in claim 1, wherein said thermosensitive color recording paper is rolled around a roll core, and said information is recorded on said roll core, and said input device is an information reading device disposed so as to confront to said roll core.

3. A color thermal printer as claimed in claim 2, wherein said information is a code.

4. A color thermal printer as claimed in claim 3, wherein said information is fixing sensitivity.

5. A color thermal printer as claimed in claim 3, wherein the number N is three, said first coloring layer is a yellow coloring layer, said second coloring layer is a magenta coloring layer, and said third coloring layer is a cyan coloring layer.

6. A color thermal printer as claimed in claim 5, wherein a peak of said first fixing light in a wavelength range is around 420 nm, and a peak of said second fixing light in a wavelength range is around 365 nm.
